(19) United States
(12) Patent Application Publication
(10) Pub. No.: US 2013/0133845 A1
(43) Pub. Date: May 30, 2013

(54) PRESSURE RELIEF PANEL

(71) Applicants: Olav Wierli, Vikersund (NO); Gunnar Brekke, Hovik (NO); Øyvind Kaasa, Ulefoss (NO)

(72) Inventors: Olav Wierli, Vikersund (NO); Gunnar Brekke, Hovik (NO); Øyvind Kaasa, Ulefoss (NO)

(73) Assignee: IKM dsc Engineering AS, Tranby (NO)

(21) Appl. No.: 13/521,189

(22) PCT Filed: Jan. 7, 2011
(86) PCT No.: PCT/NO2011/000009

§ 371 Date: Feb. 15, 2013

(30) Foreign Application Priority Data
Jan. 8, 2010 (NO) 20100019

(51) Int. Cl. E06B 9/04

(52) U.S. Cl. CPC E06B 9/04
USPC 160/210

(57) ABSTRACT

A device for shielding operation and maintenance areas comprises a frame (20) for attachment in a wall structure and one in the frame pivotably supported panel (2-5). The panel comprises two substantially plate like panel parts (5) attached to a common central member (1), and a device for pivoting the panel (1-5) between open and closed positions. The panel further comprises a top plate (2) and a bottom plate (3), between which the central member (1) and two side members (4) extend. The two panel parts (5) are release ably attached to a respective one of the side members (4), and the top 20 plate (2) and bottom plate (3) are pivotable within limits with respect to a substantially vertical axis in the area of the central member (1), said axis also substantially coinciding with the pivot axis of the panel (1-5) in the frame (20).

### TECHNICAL FIELD OF THE INVENTION

The present invention relates to panels of the active pressure relief type, especially for use within the offshore industry.

### BACKGROUND

On installations within the oil and gas industry, particularly in areas exposed to inclement weather, it is advantageous to protect work areas for maintenance and operation of equipment with shielding against wind, cold, rain and other weather. However, when closing in an area, the risk of an explosion occurring increases. If an explosion occur, the pressure in a shielded area can become 3-4 times larger than if the area had been completely open.

If an area is closed off, there will also be strict requirements for ventilation, which traditionally is fulfilled by mechanical ventilation of the closed areas, which in turn is energy consuming.

However, in difficult weather conditions it is more important to shield the work areas than to have free access to air, so that the area will in any case have to be closed for good and safe operation and maintenance, despite the increased energy consumption for ventilation.

In other words, one has the choice between complete or partly shielding. By complete shielding there will be requirements for ventilation of the shielded area, and concurrently the assumed risk for explosion becomes higher due to increased possibilities for gas formation and collection and for gas mixing.

Partly screening is assumed to reduce the risk for explosion by a factor of three. Concurrently, partly shielding will not provide sufficient protection against extreme weather of the type that may occur for instance in arctic areas.

Furthermore, it is known that working in coldness for long periods is very demanding. It has been found that persons working under such conditions gradually become apathetic from the strain and lose concentration, which obviously is not desirable, whether with respect to well-being and working environment for the workers, or with respect to operational safety.

There is a need for a device which can shield operations and maintenance areas completely when the weather so demands, while concurrently the device can be opened for ventilation when this is possible. An object of the present invention is to provide panels which may be moved between closed position for shielding an area and open position for ascertaining air supply and ventilation of the area when the weather conditions permit.

However, it will be difficult to use this type of panels in areas having particularly inclement weather conditions, such as arctic areas, where one has both strong winds and very low temperatures, and usually also precipitation. In the coldest periods, so-called weather ice or arctic snow will form on all exposed surfaces and therefore also on the panels. This ice or snow can cause the panels to freeze solid to and prevent them from being moved between closed and open position. As an example, at the Stockman field one expects up to 53 mm thick weather ice on the most heavily exposed areas.

In the shielded areas as they are made today, one must have mechanical ventilation through openings in the installation for the exchange of air. The openings are normally covered by ventilation grills, and in cold areas such grills will be provided with heating cables for melting of ice and snow in order to ascertain a constant supply of air. However, this solution is extremely energy consuming in arctic conditions due to the low temperatures and high degrees of ice and snow formation.

It is therefore also an object to provide a panel for shielding with high operational safety and high usefulness both in arctic areas and other heavy weather areas where one desires shielding of working and maintenance areas on an installation.

From GB 2388616 A there is known a panel device as recited in the preamble of claim 1. This device has a horizontal pivot axis and moving means arranged on the outside of the panel device, where it will be subject to functional disturbances in case of ice and snow. Furthermore, the panel parts are hollow to permit warm air to flow therethrough in order to prevent snow and ice from depositing thereon. The hot air flows out unhindered on the outside of the panel parts and thereby represent a large loss of energy. If the air supply should fail, the panel could freeze solid and no longer serve to relieve an explosion. Under any circumstance, an explosion would lead to the panel being destroyed and having to be replaced by a new one.

### SUMMARY OF THE INVENTION

It is an object of the present invention to provide a simple and safe manner for removing ice and snow from such panels.

The invention aims at providing so-called active panels, i.e. rotatable panels which may be pivoted about a vertical axis, where the panels may be rotated between closed and open positions. If pressure relief from both sides is desirable, the panel surfaces should be adaptable to such a situation. When the panels are in the closed position, they are to open in an ESD situation (emergency shutdown) or other unintentional shutdown of the process onboard. If an explosion occurs without prior warning, the panel should function as a passive pressure relief panel. This is obtained according to the invention as recited in claim 1.

Furthermore, the panels must be operable under conditions of weather ice and arctic snow. In such situations, there is a need for loosening the ice from the panels in a simple manner. The ice is loosened from the panels in that the lower part of the panel can be pivoted while concurrently the upper part of the panel is held fast, such that the panel is subjected to a twisting of the panel surface. This twisting of the panel surface will force the ice to loosen from the panel. The panel parts may be curved for one-sided pressure relief, or can be plain for two-sided pressure relief.

Panels according to the invention will have a number of functions when in use. They shall i.e. function as a passive pressure relief panel in an unexpected explosion.

Furthermore, when a gas is detected inside the module, a signal is given to a control unit (ESD=emergency shut down or unplanned shut down). In such a situation the panel should be opened quickly in order for the gas to be ventilated out by means of natural ventilation.

When the weather conditions permit, the panels shall be opened/pivoted so that natural ventilation is obtained substantially as in an open module.

Under special weather conditions, weather ice and/or arctic snow will form that could tend to hinder the panels from functioning as intended.

### BRIEF DESCRIPTION OF THE DRAWINGS

The invention will be described more closely by means of an exemplifying embodiment in the appended drawings, where:

FIG. 1a shows a perspective view of a part of a wall with a panel according to the invention seen from a first side, preferably the front side, in closed position.

FIG. 1b shows a perspective view of part of a wall with a panel according to the invention seen from a first side, preferably the front side, in open position.

FIG. 2a shows a perspective view of part of a wall with a panel according to the invention seen from another side, preferably the rear side, in closed position.

FIG. 2b shows a perspective view of part of a wall with a panel according to the invention seen from another side, preferably the rear side, in open position.

FIG. 3 shows a side view of part of a wall with panels according to the invention.

FIG. 4 shows a cross-section of the part of the wall along the line A-A in FIG. 3.

FIG. 5 shows a cross-section of the part of the wall along the line B-B in FIG. 3.

FIG. 6 shows a cross-section of the part of the wall along the line C-C in FIG. 3.

FIG. 7 shows a cross-section of the part of the wall along the line H-H in FIG. 3.

FIG. 8 shows a detailed view of the section D in FIG. 6.

FIG. 9 shows a detailed view of the section L in FIG. 6.

FIG. 10 shows a detailed view of the section K in FIG. 6.

FIG. 11 shows a cross-section along N-N in FIG. 7.

FIGS. 12a-d shows the panel according to the invention in perspective views and partial views.

### DETAILED DESCRIPTION

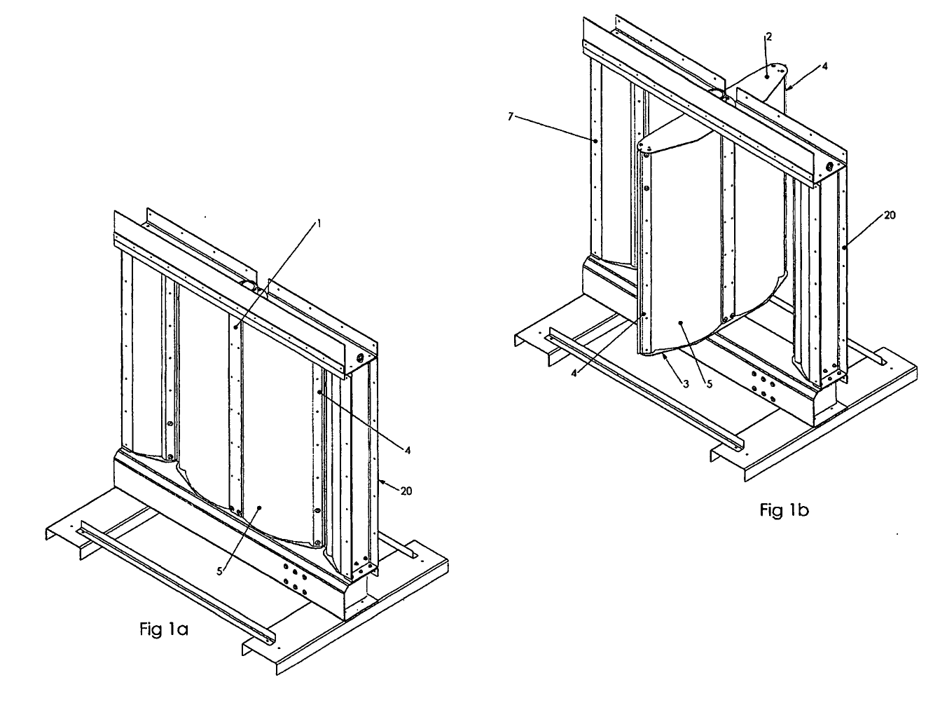

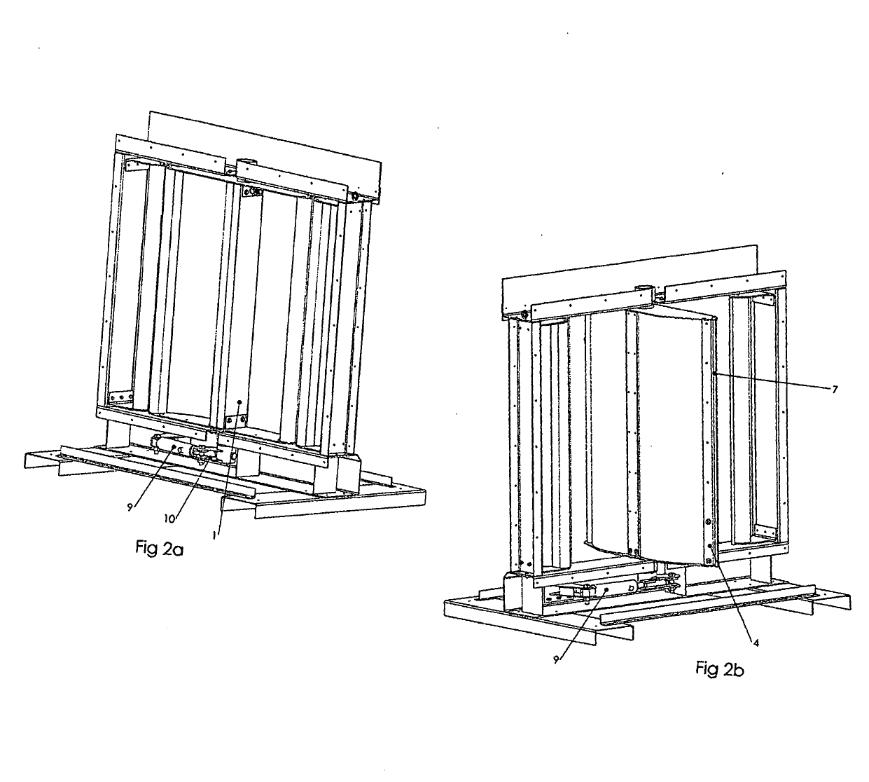

FIGS. 1a and 1b show a perspective view of part of a wall having an active panel 20 in accordance with the invention seen from one side, while FIGS. 2a and 2b show a perspective view of the part of the wall having an active panel 20 according to the invention seen from the other side. The panel comprises a vertical torsion-weak middle member 1 (seen best in FIG. 2a) which is attached to a top plate 2 and a bottom plate 3 (seen best in FIG. 1b), A torsion pipe 8 extends through the torsion-weak member 1. On either side of the member 1 a vertical side member 4 is mounted, which is attached to the top plate 2 and bottom plate 3. A curved plate element 5 is attached to the member 1 and lies in a slot 6 (see FIG. 8) in the side member 4.

The plate elements 5 will usually curve outwards from the shielded areas. At a given overpressure from the inside, they will be deformed further, and will be opened in an internal explosion. This is often called passive explosion protection.

A hydraulic cylinder 9 below the panel 1-5 is mounted to the torsion pipe 8 by means of a cylinder bracket 10, see FIGS. 2a and 2b, so that the lower part of the torsion pipe 8 can be pivoted by pushing the cylinder bracket 10 back and forth by means of the hydraulic cylinder 9.

The member 4 may be provided with holes 7 through the entire member for placing a heat tracing cable (not shown). Heat tracing cables may be installed as a precaution in extreme conditions with weather ice and arctic snow.

The panel is opened by the hydraulic cylinder 9 by pivoting the torsion pipe 8, which is fixedly attached to the bottom plate 3. At the top of the torsion pipe there is a bearing 12 in the frame 20, see FIG. 9, in which the torsion pipe 8 rotates. The top plate 2 is connected to the pipe 8 by means of a through-going bolt 13, which may transmit torque from the torsion pipe 8 to the member 1.

By making the hole in the member 1 for the through-going bolt 13 oval, the pipe 8 with the bottom plate 3 can be twisted a given number of degrees past the closed position, while the top plate is held in the closed position against one or more abutments in the frame 8. Thus, one obtains a twisting in the vertical torsion weak member 1 which propagates to the curved plate elements 5, so that the surface which is covered by ice is twisted out of contact with the ice. The frame may also have abutments that will stop the top plate in open position for loosening of snow and ice.

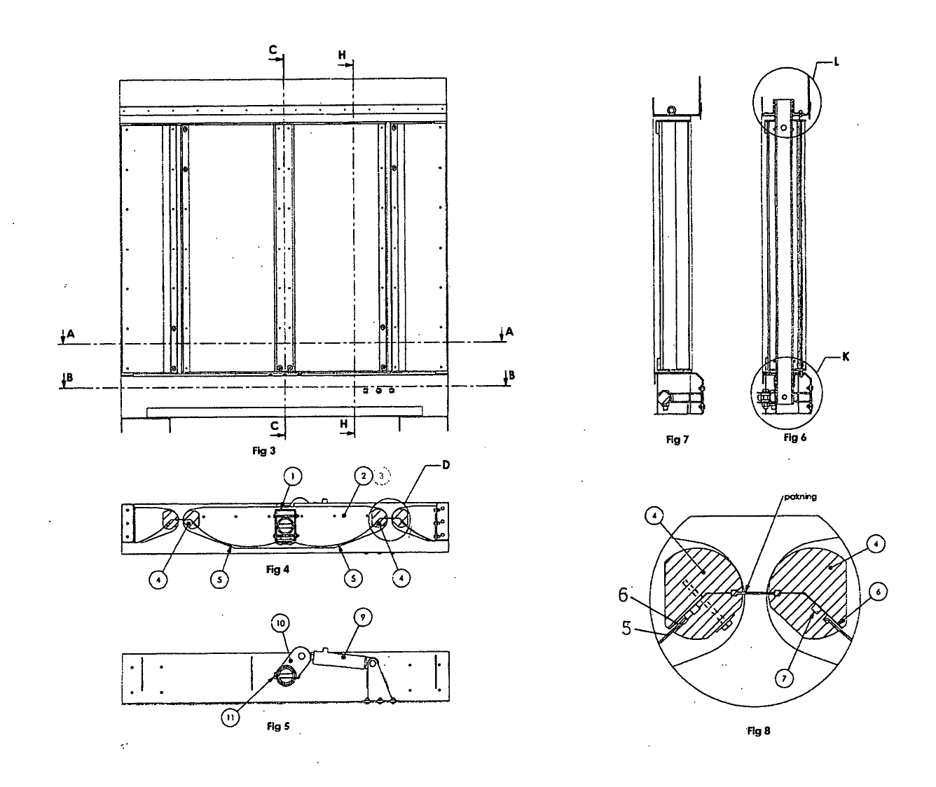

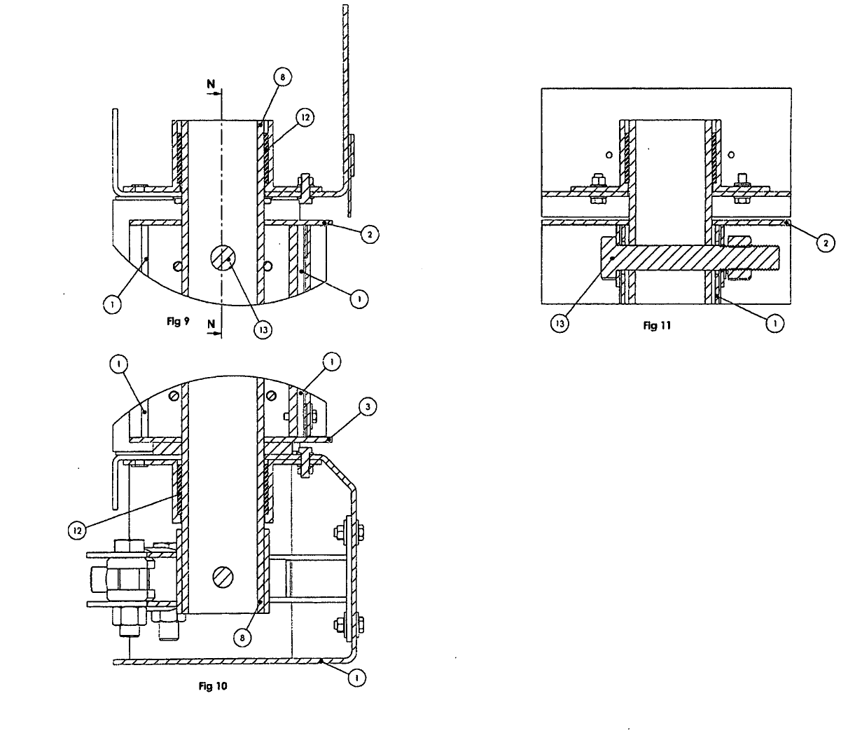

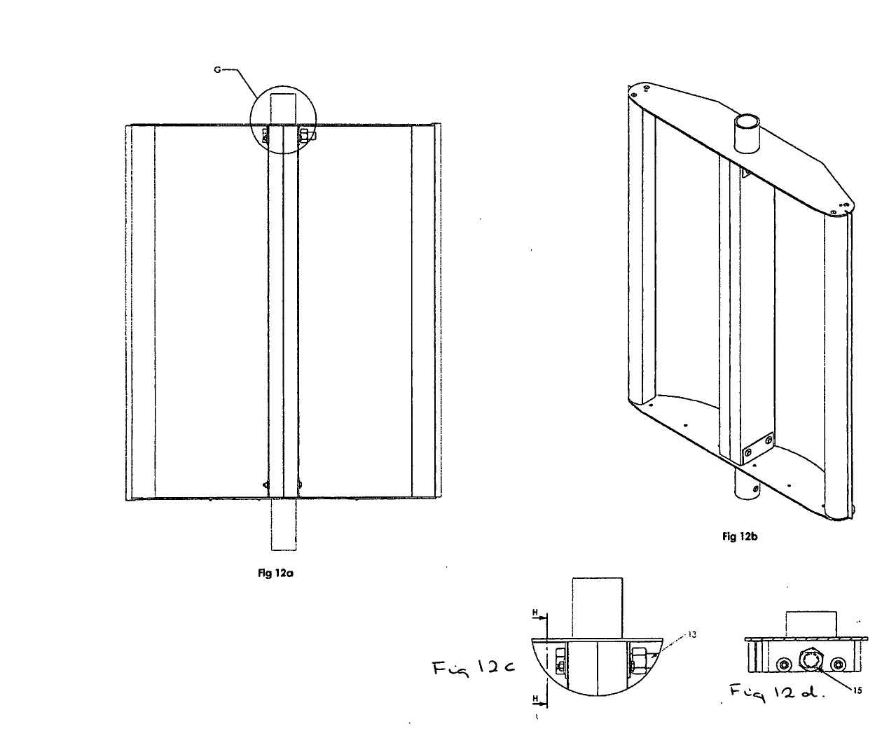

FIGS. 4-11 show different details of the panel according to the invention. The cylinder bracket 10 is attached to the torsion pipe 8 by means of a bolt 11, see FIG. 5.

FIGS. 12a-d show the panel according to the invention in perspective view and in part views. The torsion pipe 8 is attached to the vertical member 1 by means of one or more through-going bolts 13. These bolts are placed in oval slots 15 near the top plate 2, while the bolts at the bottom plate 3 are placed in fitted bolt holes (not shown), so that the lower part of the torsion pipe closely follows the movements of the cylinder bracket, see FIG. 5.

If desirable, it is obvious that one may have oval slots at the bottom plate 2 and fitted bolt holes at the top plate 3, and/or place the control unit for rotation of the torsion pipe at the upper edge rather than at the lower edge of the panel.

Furthermore, one may envision that a cylinder can drive the movement of more than one panel by letting a plurality of cylinder brackets be connected to the hydraulic cylinder arm. If desirable, also other means for pivoting the torsion pipe may be used, such as chain devices, drive belts, a toothed rod, or other means.

While restricted by ice the bottom plate 3 and top plate 2 may be given a mutual twisting which will remove ice due to deformations in the panel structure.

If desirable, sealing devices may be installed along one or more of the edges of the panel 1-5 to provide further insulation when the panel is in the closed position. For instance, a sealing device in the form of a skirt may be mounted to the lower edge of the bottom plate 3.

An advantage of the present invention is its simple and cost-effective way of removing ice and snow from the panel. The ice/snow is removed by controlled deformation between the top and bottom of the panel. The resistance from the ice against the deformation makes the ice loosen.

Since the panel is vertically oriented, it can take high loads from ice and snow which will not prevent safe operation. The load from ice and snow attaching itself to the vertical surfaces will not load the surface of the panel to any degree.

The panel may be pivoted so that air may be introduced into the work area independent of the wind direction. Concurrently, it functions as a passive pressure relief panel. An advantage of the present invention is therefore that one obtains a combination of a passive pressure relief panel and an active panel.

The panel can ventilate explosions both ways; at the same time, the solution has a low energy requirement and a small need for heat tracing. Use and operation of the system is obtained by means of hydraulics, ESD signal system and electric power, which makes the system cost efficient and relatively simple to install and operate.

1. A device for shielding operating and maintenance areas, comprising
a frame for attachment to a wall structure and a panel pivotably supported in the frame, said panel comprising
two substantially plate like panel parts attached to a common central member, and
a device for pivoting the panel between open and closed positions, wherein the panel further comprises a top plate and a bottom plate, between which the central member and two side members extend, in that the two panel parts are releasable attached to in a respective one of the side members, and in that the top plate and bottom plate are moveable within limits with respect to each other about a substantially vertical axis in the area of the central member, said axis also substantially coinciding with the pivot axis of the panel in the frame.

2. The device according to claim 1, wherein the central member is sufficiently weak in torsion to permit said limited pivotability between the top plate and the bottom plate.

3. The device according to claim 1, wherein the panel parts each comprise a substantially curved plate.

4. The device according to claim 3, wherein a side edge of the curved plate is received in a pocket in the respective side member.

5. The device according to claim 1, wherein the devices for rotation of the panel comprise a cylinder bracket mounted to the torsion pipe and to a hydraulic cylinder, such that the cylinder bracket rotates the torsion pipe when it is moved by the hydraulic cylinder.

6. The device according to claim 1, wherein the panel is provided with heat tracing cable.

7. The device according to claim 1, wherein sealing devices are provided along one or more of the end surfaces of the panel.

8. The device according to claim 1, wherein the side members comprise two parts which are bolted together.

9. The device according to claim 1, wherein the wall comprises one or more panels.

10. The method of shielding using the device according to claim 1 in a protective wall.

11. The method according to claim 10, wherein the central member is sufficiently weak in torsion to permit said limited pivotability between the top plate and the bottom plate.

12. The method according to claim 10, wherein the panel parts each comprise a substantially curved plate.

13. The method according to claim 12, wherein a side edge of the curved plate is received in a pocket in the respective side member.

14. The method according to claim 10, wherein the devices for rotation of the panel comprise a cylinder bracket mounted to the torsion pipe and to a hydraulic cylinder, such that the cylinder bracket rotates the torsion pipe when it is moved by the hydraulic cylinder.

15. The method according to claim 10, wherein the panel is provided with heat tracing cable.

16. The method according to claim 10, wherein sealing devices are provided along one or more of the end surfaces of the panel.

17. The method according to claim 10, wherein the side members comprise two parts which are bolted together.

18. The method according to claim 10, wherein the wall comprises one or more panels.
